(19) United States
(12) Patent Application Publication
(10) Pub. No.: US 2023/0385386 A1
(43) Pub. Date: Nov. 30, 2023

(54) Non-Commutative Node-Centric Digital Rights Management System

(71) Applicant: Peepline LLC, Incline Village, NV (US)

(72) Inventors: Michael Sandler, Incline Village, NV (US); Leopold B Willner, Petaluma, CA (US); Blake Anderson, North Saint Paul, MN (US)

(21) Appl. No.: 18/202,212

(22) Filed: May 25, 2023

Related U.S. Application Data
(60) Provisional application No. 63/346,239, filed on May 26, 2022.

(51) Int. Cl. G06F 21/10; G06F 21/62

(52) U.S. Cl. CPC G06F 21/105; G06F 21/6218

(57) ABSTRACT

Methods and apparatus consistent with the present disclosure may be used to create Internet apps and associated websites that bring human-levels of personal trust and intimacy/closeness into use while people are messaging and posting on a fully secured private peer-to-peer Internet communication system empowered by distributed ledger technology and applications. This disclosure reviews useful ways of bringing personal freedom and personal rights using methods that may be objective or subjective using methods that allow users to manage licensing and the fair use of their intellectual property and other information. Meaning an advanced technology that makes manifest the much-needed Enlightenment of the Internet desired by so many thoughtful and concerned people in the US and within the very vocal leadership of the EU. Communications sent between devices may be secured using encrypted such that only users of end devices or nodes may review data sent from another device.

### CROSS-REFERENCE TO RELATED APPLICATIONS

The present disclosure claims priority benefit to U.S. provisional patent application 63/346,239 filed on May 26, 2022 the disclosure of which is incorporated by reference herein.

### BACKGROUND OF THE INVENTION

### Field of Invention

The present invention generally relates to a non-commutative peer-to-peer node-centric rules-based communications between nodes (e.g. computing devices) of a communication network. More specifically, the present invention relates to a new form of digital rights management.

### Description of the Related Art

One of the great threats to privacy and to the security of computer data relates to how most public computer networks are presently organized and centrally managed. Therein, individuals commonly communicate with each other via an electronic medium where messaging and other data is stored at servers or data storage devices of various companies. Companies that provide services of electronic mail (email), social media communications, and text messaging, that store communication data at a data center operated or leased by these companies. Even when encryption and other security measures are used to protect this data, hackers, spies, corporate intruders and various forms of malware (e.g. spyware & computer viruses) have stolen or otherwise misused data belonging to millions of unknowing private people, along with data mining and personal profiling for commercial purposes. Current data rights management systems are administrated by a centralized authority that acts as a repository for content in a way that allows a content aggregator to extract fees for administrating the share of content to licensees or that allows for users to participate in a private development effort. This allows for content aggregators to collect fees that could otherwise be paid to content creators instead of middlemen. Furthermore, such centralized content aggregators store content from many (e.g. thousands or millions of content providers) are subject to hackers where one breach could result in each of those many pieces of content being stolen.

What are needed are new methods and apparatus that secure and share data in new ways.

### SUMMARY OF THE CLAIMED INVENTION

The presently claimed invention relates to a method, a non-transitory computer readable storage medium, art apparatus, or as a system of devices. In one embodiment, a presently claimed method includes receiving from a first user device a trust level and an intimacy level to associate with a second user and a set of data. Here the trust level and the intimacy level associated with the second user correspond to a rule for providing the dataset to a second user device. This method may also include storing information that identifies the second user device, where the stored information also associates the trust level and the intimacy level with the second user device identifying information. Next this method may continue by initiating a key exchange process that results in a first key being stored at the first user device and at least one other key being provided to the second user device and allowing the second user device to access the data according to the trust level and the intimacy level based on the stored information associating the trust level and the intimacy level with the second user device identifying information.

### BRIEF DESCRIPTION OF THE DRAWINGS

FIG. 1 illustrates several different computers that may communicate with each other to facilitate the secure sharing of data between nodes according to a set of rules.

FIG. 2 illustrates a series of steps that may be performed when a key exchange is performed.

FIG. 3 illustrates a series of steps that may be performed at a user device when a user wishes to share data with other user devices based on trust levels and intimacy levels.

FIG. 4 illustrates a computing system that may be used to implement an embodiment of the present invention.

### DETAILED DESCRIPTION

Methods of the present disclosure relate to a quasi-peer-to-peer node-centric rules-based communications between the nodes (e.g. specific computing devices) of a communication network. Methods and apparatus of the present disclosure may allow users to set rules that control data sharing between nodes using non-commutative signaling between nodes that communicate via an electronic communications network. Copyrighted data or other data may be sent between smartphones, personal computers (e.g. laptops and handheld devices), and private servers via the Internet and/or private networks. This may be performed in a manner that emphasizes security, privacy, personal trust and intimacy in new ways that protect individual rights, common in free societies and mostly absent on an Internet dominated by corporate interests. Methods consistent with the present disclosure enable data to be protected based on source nodes that allow the sharing of protected or confidential information securely with other nodes. Each of these nodes may be user devices that belong to users that have been assigned the rights to access data.

Non-commutative node-centric network rules and protocols may be used to identify user devices that are authorized to receive protected content (e.g. copyrighted content private content) in a secure way. Computers of individual copyright holders may share copyrighted data directly to computers of users licensed to access specific set of copyrighted data. Such methods allow data to be shared in a way that scales to data storage access limitations of particular nodes. For example, a particular node may only store large data sets that include pluralities of copyrighted data. In certain instances, only non-video related data or data with limited video content may be shared from a particular data source. Shared content may also be managed using sets of virtual devices implemented within a particular computer system. In such an instance, software of a particular set of hardware may share different sets of content via different sets of virtual computers.

Embodiments of the present disclosure may be directed to a method, a non-transitory computer readable storage medium, and other apparatus of a quasi-peer-to-peer fully secured private communications away from the grasp and commercial exploitation of corporate interests and advertisers via big data mining, machine learning and personal profiling, without the specific permission and compensation of the parties concerned. Private information may only be held (i.e. stored or displayed) on private computing devices (e.g. smartphones, laptops, computers, and/or private servers). Private dossiers may be used to store information on personal contacts, individuals that license content, or members of a collaborative effort. This information may be used as a mental prosthesis to enable better, more accurate, trusted and intimate communications among private parties. Methods of the present disclosure may define and enable a new form of Internet and its media architecture that deserves to be characterized as ‘personal media.’ This personal media is empowered by a distributed node topology network that functions via: 1) peer-to-peer (or what may be referred to as a quasi-peer-to-peer) encrypted communications architecture, 2) minimal server interactions, which may always be out of reach of commercial networks and big data intrusions on privacy, 3) ways of communicating among users secured by the highest level of privacy and security enabled by client ratings on trust and intimacy/closeness between individuals, 4) by matching data relevant to their audience via search, filtering and other capabilities using personal dossiers only stored on users private devices, and thus out of the reach of public and commercial networks, 5) new convenient high speed ways of selecting just the right ad hoc audience for shared data, 6) an architecture that fosters and enables the evolution and use of smart contracts, and 7) communication rules and protocols defined on individual peer-to-peer or quasi-peer-to-peer links by the peers themselves that are non-commutative. All of which will tend over time to raise trust and confidence and bring users and user groups ever closer together. In the present disclosure, the terms confidence and sentiment may be used interchangeably, and measures of levels of confidence or sentiment may be a function of measures or levels of trust and intimacy assigned by a particular user.

The terms quasi-peer-to-peer, non-commutative peer-to-peer, quasi-peer-to-peer links, and quasi-peer-to-peer communications may refer to the fact that communication rules between specific compute nodes may be non-commutative. This may allow a master or source compute node to share data with compute nodes that are authorized to receive content or participate in an exchange of information relating to a subject or endeavor.

In certain instances, methods of the present disclosure include individually centered and controlled personal media where all data is kept strictly secure and private and potentially managed within a distributive ledger technology system (DLT) and communicated among users (nodes) of its non-commutative, node-centric data communication network. Methods of the present disclosure allow owners of content to share that that content with licensees and allow a group of individuals to collaborate with each other in a secure way. These methods may allow certain computing devices to participate in a collaborative work environment that allows participants to provide data to other participants in a private and secure way via their respective computing devices.

Distributed ledge technology (DLT) is a technology that may be used to record the transaction of assets in which transactions and their details are recorded in multiple places at the same time. Unlike traditional databases, distributed ledgers have no central data store or administration functionality. In a distributed ledger, each node processes and verifies every item, thereby generating a record of each item and creating a consensus on its veracity. A distributed ledger can be used to record static data, such as a registry, and dynamic data, such as financial transactions. Blockchain is a well-known example of a distributed ledger technology. DLT specifically to the technological infrastructure and protocols that allow the simultaneous access, validation and updating of records that characterizes distributed ledgers.

DLT may be used on a computer network spread over multiple entities or locations, and DLT may use cryptography to securely store data, cryptographic signatures and keys to allow access only to authorized users. The technology also creates an immutable database, which means information, once stored, cannot be deleted and any updates are permanently recorded for posterity. DLT represents a significant change in how information is gathered and communicated by moving record-keeping from a single, authoritative location to a decentralized system in which all relevant entities can view and modify the ledger. As a result, all other entities can see who is using and modifying the ledger. This transparency of DLT provides a high level of trust among the participants and practically eliminates the chance of fraudulent activities occurring in the ledger. As such, DLT removes the need for entities using the ledger to rely on a trusted central authority that controls the ledger, or an outside, third-party provider to perform that role and act as a check against manipulation. A main difference between DLT and traditional, centralized ledgers is that a copy of the ledger is distributed to each node on the network, and every node can view, modify and verify the ledger, which helps ensure trust and transparency.

Asymmetric or non-commutative local rules-based sets of protocols may apply to provide enhanced privacy and security to enable a high level of personal trust, intimacy, and confidence or sentiment in the interactions of two or more individual computers using its node-based communications. A non-commutative property of this network arises out of the fact that what may be a suitable and allowable data from a first node (node A) to a second node (node B) may not be suitable or allowed in reverse, from node B to node A, wherein a different set of rules may apply. This is due to the asymmetry of its node-centric rules in both transmission and function. Such rules may allow only certain licensed users or authorized user devices to access content or participate in the sharing of data. DLT may be used along with the aforementioned rules to help manage digital rights, when maintaining records associated with licensed digital content, and when managing payments associated with the licensing of digital content.

In one instance, a node may send communications or data using trust parameters, intimacy parameters, and possibly interest parameters that may link nodes according to a star system model with node recall where:
Each node nₓ, of user x is to have a coded set of associated “licensee, collaborator, friends, family and colleagues”, its group of nodes such as node n_{y} representing the trust and intimacy group, [Pₓ(y)], of a star shaped graph. Here [Pₓ(y)] may refer to a group P of contacts of user x (i.e. Pₓ) that include user or users y.
Each such node n_{y} connected in this way to node nₓ may be attributed with levels of trust T, as Tₓ(y), and intimacy I, as Iₓ(y), as well as A for an Interest (in a type of content or relating to a subject of a collaborative effort), once coded in metadata or tags may influence what messaging user x may choose to send to user(s) y, from node nₓ to node n_{y}. Here Tₓ(y) may refer to levels of trust T that that user x (i.e. Tₓ) has associated with user or users y. Similarly, Iₓ(y) may refer to levels of intimacy I that user x (i.e. Iₓ) has associated with user or users y.

The respective notations Pₓ(y), Tₓ(y), and Iₓ(y) discussed above may alternatively be represented using notations P_{xy}, T_{xy}, and I_{xy}

A user may assign each of their contacts with a trust level and an intimacy level. Various representations may be used to identify trust levels and intimacy levels. In one instance, levels of trust and intimacy that may be assigned integers 1, 2, or 3 to identify respective levels of trust and intimacy. Here the number 1 could correspond to a lowest level, the number 2 could correspond to a medium level, and the number 3 could correspond to a high level. In other instances, levels of trust and intimacy may be represented using alphabetic characters (letters). Table 1 illustrates exemplary numbers and letters that could be used to identify respective levels of trust and intimacy, where the numbers could also be in a digital or continuous range (say) between zero and ten.

TABLE 1
Alphabetic and Numeric Level Representations
Alphabetic and Numeric Level Representations

| | | | |
|---|---|---|---|
| A | Trust High | 3 | Intimacy High |
| B | Trust Medium | 2 | Intimacy Medium |
| C | Trust Low | 1 | Intimacy Low |

Table 1 indicates an instance where a low trust level and a low intimacy level both correspond to the letter C or to the number 1, where a medium trust level and a medium intimacy level both correspond to the letter B and the number 2, and where a high trust level and a high intimacy level both correspond to the letter A and to the number 3.

These levels of trust and intimacy are personal to each ordered pair of users x and y and may be understood as the level of personal confidence/sentiment user x has in communicating with user y, represented as C_{xy} or Cₓ(y), and in reverse order in C_{yx} or C_{y}(x) where at times these two do not match. Herein, C_{xy}=C_{xy}(T_{xy},I_{xy}), relates the level of confidence in terms of the trust of x in y as in T_{xy}=(low, medium or high) or any other set of such measures. Similarly, the same may apply to intimacy ratings for I_{xy}, the level of intimacy or closeness user x has with regard to user y. Here, the confidence that x has in communicating and participating in other activities with user y is represented by a pair, (T,I), of qualifiers or conditions that a sender user x holds regarding a user y; while signaling along the network edge from nₓ to n_{y}.

In an instance, this may be represented in a table of pairs representing the sentiment or confidence/sentiment an initiator x has in dealing with a receiving party y in such a network, as shown in Table 2 or ordered pairs (T,I) where the numbers are indices representing levels such as low, medium and high or other kinds of ratings wherein a confidence/sentiment function C=C(T,I) yields human confidence/sentiment ratings or levels—its human master.

TABLE 2
Numeric Trust/Intimacy Ratings or Indices

| | Trust, | Trust, | Trust, |
|---|---|---|---|
| | Intimacy | Intimacy | Intimacy |
| Sets of | 3, 1 | 3, 2 | 3, 3 |
| Ordered Pairs | 2, 1 | 2, 2 | 2, 3 |
| | 1, 1 | 1, 2 | 1, 3 |

While tables 1 and 2 and related text discusses trust and intimacy levels (e.g. A, B, & C; and 3, 2, 1) that correspond to levels of confidence or sentiment, methods of the present disclosure may use any number of levels of trust and intimacy and these levels may instead be referred to as ratings or rankings of trust and intimacy where different combinations of trust ratings/rankings and intimacy ratings/rankings correspond to different ratings, rankings, or levels of confidence or sentiment. For example, ratings of trust may span a numerical range of 1 to 10 and ratings of intimacy may span numerical range of 1 to 5. For this reason, the terms level, rating, and ranking may be used interchangeably.

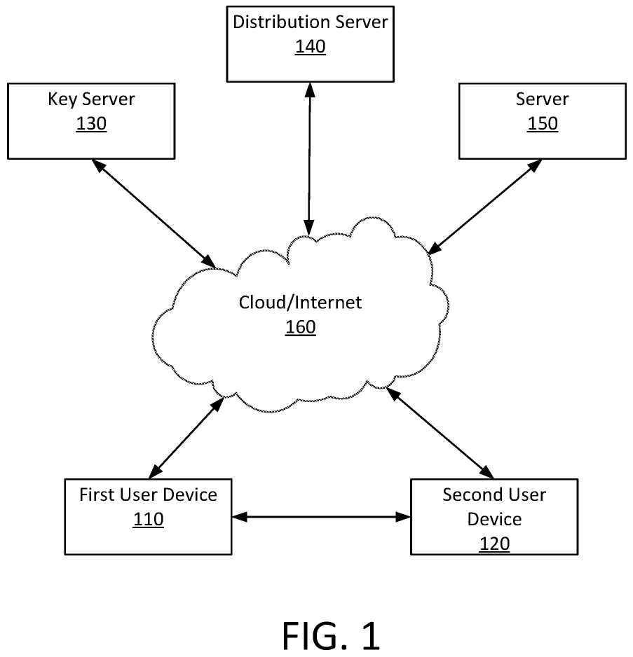

FIG. 1 illustrates several different computers that may communicate with each other to facilitate the secure sharing of data between nodes according to a set of rules. FIG. 1 includes a first user device 110, a second user device 120, a key serer 130, a distribution server 140, and a signal server 150 that may communicate with each other over a computer network (i.e. cloud or Internet) 160. In certain instances, the first user device 110 and the second user device 120 may communicate directly with each other. This may include communicating via a private network, using device to device communications according to standards like Bluetooth, or via a device that transfers data without storing that data persistently.

Key server 130 may be used to generated keys that may be used to encode or decode data shared between user devices. In certain instances, the functionality of key server 130 may be performed by a user device that stores copyrighted or other protected data belonging to an entity or first user. For example, when the first user device 110 hosts a set of protected data (e.g. a book written by art owner of first user device 110) and when a second user device wishes to license that set of copyrighted data, the second user device may provide payment information as part of a process where a user of the second user device 120 signs up as a licensee of the set of protected data. A key exchange may then be performed that would enable the first user device 110 to provide encoded data to the second user device 120 by one or more communication pathways.

In one instance, the system of FIG. 1 may use a form of triple-Diffie-Helman encryption where key server 130 may generate three keys, provide a first key—a second key—and a third key to the first user device 110, provide the second key to distribution server 140, and provide the third key to user device 120. To decode data sent from the first user device 110, both the second key and the third key would have to be applied to decrypt the data sent from the first user device 110. Encoded data provided by the first user device may be stored at the distribution server such that the second user device 120 may access that data even when the first user device 110 is turned off. Data stored at the distribution server 140 may be stored in its fully encoded form and when the second user device 120 attempts to access this data, distribution server 140 may apply the second key (to partially decode the encoded data) and then send that partially decoded data to second user device 120. Once the second user device 120 receives the partially decoded data from distribution server 140, the second user device 120 may apply the third key to complete the process of decoding the data that was shared from the first user device 110.

The use of three keys is inherently more secure than using only two keys for various reasons. Even so, methods of the present disclosure may use fewer than three keys or more than three keys in given instances. For example, two keys could be used, a first key at the first user device 110 and a second key at second user device 120, where the distribution server distributes encoded data received from the first user device 110 that can be decoded at the second user device 120 using the second of the two keys.

Communications between the first user device 110 and the second user device 120 may be passed through a computer or server (i.e. transfer server or signal server) 150. Here server 150 may not decode data sent between user devices 110 and 120. Instead, server 150 may simply forward data it receives. Alternatively, or additionally data may be sent directly from the first user device 110 to the second user device 120 directly via a wired or wireless communication medium. For example, using 802.11 (Wi-Fi wireless radio), Bluetooth, or Li-Fi visible light communication technologies.

Even when communications are sent via transfer/signal server 150 or directly via a wired or wireless medium, either two keys or three keys may be used to secure that data. For example, the first user device 110 may store data that requires two keys to be applied to decode the stored encoded data. The first user device may identify that the second user device should be provided with data that has been partially decoded and the first user device may use the second key to partially decode the data and then send that data to the second user device 120 either directly or through transfer/signal server 150.

Because of this, the first user device 110 may share data via one more different communication pathways depending on requirements associated with a given pathway. As such, user device 110 may identify a pathway to use to share data with the second user device 120 and may then share the data according to a rule associated with the identified pathway.

A collaborative work environment may work in similar ways as the sharing or data from the first user device 110 to the second user device 120 and possibly other user devices that are associated with a certain collaborative effort or project. Collaborations could be performed via distribution server 140, through transfer/signal server 150, may be performed directly between user devices (e.g. via a private network or direct communication channels). A collaborative effort may include sending communications to user devices that are located within boundaries of a secure facility (e.g. within a building) using communications that do not exit the boundaries of the secure facility. In such an instance, communications may be sent via a private computer network or directly from device to device without use of the private computer network. Alternatively, or additionally communications may be sent via the cloud or Internet 160 possibly via distribution server 140 and/or server 150.

In an instance when a server participates in the sharing of content and then that server fails, licensed content may be accessed via another pathway or directed from a user device of an owner of the licensed content. In one example, when distribution server 140 is being used by second user device 120 and distribution server 140 fails, the second user device 120 may access content at the first user device 110 via direct device to device communications or using communications sent via a computer network (e.g. the Internet 160, a cellular network, or other network). Alternatively, when distribution server 140 fails, the second user device 120 may access content at server 150. Since user device 110 may store all keys associated with sharing a dataset with user device 120, user device may provide data to user device 120 that user device 120 can decode. Such alternate communication pathways, therefore, provide fault redundancy or a fail over capability making this node to node data sharing system more reliable.

Fees associated with a smart contract, digital rights management fees, and other transactional costs of the present disclosure may be paid in the form of a type of token that are similar to non-fungible tokens in a manner similar to how Ethereum derivative tokens are used. A third-party may earn service fees that may be charged according to a schedule. Such service fees may be at a flat rate, may be based on a percentage of a total license fee, and may include micro-transactions. This third-party may be a same entity that provided software to nodes that participate in the sharing of data. This may include using a form of cryptocurrency and DLT.

In one instance, several different entities may participate in DLT transactions where records at computers of an entity that shares content, a third-party service and/or software provider, and a licensee are updated when ledgers at each of these respective computers are updated and where fees may be charged based on the use of cryptocurrency tokens. Here a third-party may be a company that provided software to various nodes used to share data or that operate the distribution server or both. By using encryption and DLT, such transactions are completed in a secure and immutable way.

The DLT administrated transactions may also rely upon use of shared keys and these keys may be used on an instance-by-instance or case-by-case basis that may allow for several tiers of fees. Such fees may be distributed on a per use or volume basis, where fees may change based on volume. This process may include the use of several different digital wallets, a first wallet associated with a content owner, a second wallet associated with a licensee, and a third wallet associated with a third-party. In certain instances, fees may be fulfilled in batches instead of immediately paid upon them being due. This may include, informing each node that one or more transactions are pending and will be fulfilled according to a batch process schedule. The status of pending, due, and paid transactions may also be recorded using DLT.

In certain instances, DLT transactions may be implemented using a first layer of software that administrations basic distributed ledger updates, for example using an existing blockchain system and may implemented using a secondary software framework (i.e. a second layer of software) that operates above the first layer of software. This second layer could be implemented on top of a blockchain where transactions are transferred between parties that are not on the blockchain network. For example, computers that belong to a provider of content and a licensee of that content may be part of a blockchain network, where a third-party computer that receives service fees is not. This may be performed by use of a multiple-party transaction method where parties may received fees from other parties.

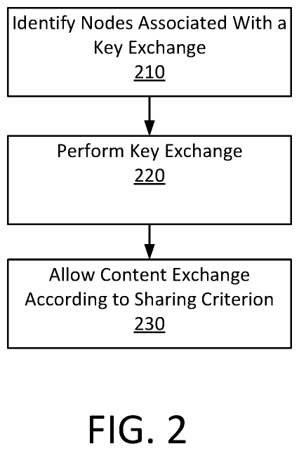

FIG. 2 illustrates a series of steps that may be performed when a key exchange is performed. The steps of FIG. 2 may be performed by a key server such as the key server 130 of FIG. 1 or may be performed by a user device that provides shared content. FIG. 2 begins with step 210 where nodes that should participate in a key exchange are identified. This process may be initiated based on information being received from a user device indicating that a user of that user device wishes to license content or wishes to participate in a collaboration. Once various parties have agreed to license sharing terms or to a collaboration, the steps of FIG. 2 may be performed.

After the devices have been identified, keys may be exchanged between parties in step 220 of FIG. 2. In an instance when a key server is used to transfer keys, that key server may generate keys in a manner that may include participation of a user device that provides data to other user devices, such as the first user device 110 of FIG. 1. This process may include the generation of a private key that resides at this first user device. This first key may be generated by a processor of the first user device during a process that generates the first key, a second key, and a third key. The key server may receive the second and the third key and then provide the second key to a distribution server, such as distribution server 140 of FIG. 1. The key server may then send the third key to a second user device. The key exchange process may result in the first user device storing the first key, the second key, and the third key.

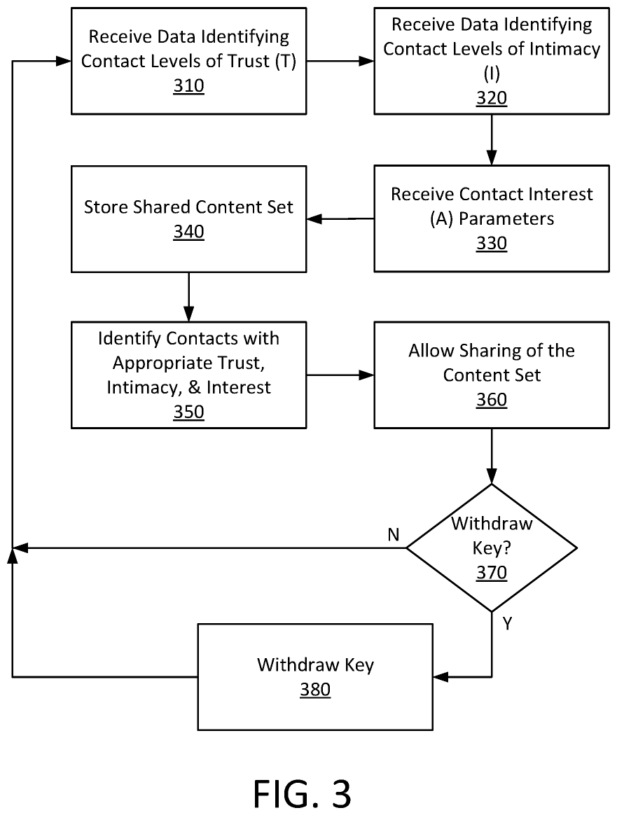

Next in step 230 of FIG. 2, content/data may be allowed to be provided to the second user device via the distribution server or via a direct network connection. This content or data may be shared with the second user device based on a sharing criterion that may be associated with the levels of trust, the levels of intimacy, and possibly the contact interest parameters discussed in respect to FIG. 3.

When ever the second user device wishes to access content provided by the first user device, the second user device may access that content via one or more different pathways. In one instance, the shared content or portion thereof may be sent to the distribution server. This portion of shared content may be stored at the distribution server after it is received from the first user device. The distribution server can apply the second key to the portion of shared content whenever the second user device connects to and downloads that portion of the shared content. The second user device may then apply the third key such that a user of the second user device can review the shared content.

In an instance when the first user device wishes to stop sharing content with the second user device, the first user device may send data to the distribution server that results in the second key being disabled or erased/deleted from a data storage at the distribution server. After this point in time, in instances when the second user device attempts to access the previously shared content, the distribution server could not apply the second key. For example, the absence of the second key or the withdrawal of the second key would mean that the distribution server could not be provide data to the second user device that the second user device could decode. Even if the distribution server did provide data to the second user device, the second user device could not fully decrypt the data without the second key being applied. At a later point in time, the second user device may re-establish a license or a collaboration and this could result in a new set of keys being generated and shared or it could result in the distribution server changing a status of the second key from “withdrawn” to “allow.”

In certain instances, the first user device and the second user device may share data directly via a private network or via a transfer or signal server such as transfer/signal server 150 of FIG. 1. In such an instance, the first user device may apply the second key to the portion of shared data before sending that data to the second user device. In such instances, the first user device may delete one or more of the keys or may place one or more of the keys in a “withdrawn” state.

The methods of FIG. 3 may include changing sharing operations depending on a particular pathway currently being used to share content. Data could be made available to the second user device both through a distribution server or directly. When the second user device is located within a secure facility, data could be shard directly from the first user device to the second user device. In an instance, when the second user device moves outside of the secure facility, data may be shared with the second user device via a distribution server or a transfer/signal server. This may require the first user device to both withdraw shared keys at the first user device and at the distribution server in instances when the data sharing operations between the first and the second user device are terminated.

A similar key sharing process may occur to secure data sent from the second user device to the first user device. This may allow the second user device to control what data that the first user device may receive from the second user device at a given point in time. During a collaboration, for example, the second user device may store testing data, planning data, or other data relating to an effort that users of both the first and the second user device are working on. At this time, the data stored at the second user device may be protected in a manner that allows a user of the second user device to withdraw access privileges that were previously granted to the first user device. A collaboration could include multiple different users that each operate their own user device and each of these respective users/user devices may be associated with each other according to a set of rules of a criterion.

In an instance when content is licensed by a first user, a user device of that first user or a related distribution server may share content with any number of user devices according to a set of rules. This could allow the first user to provide different licenses to any number of different user devices. Each respective user device may be associated with different sets of keys.

FIG. 3 illustrates a series of steps that may be performed at a user device when a user wishes to share data with other user devices based on trust levels and intimacy levels. Particular sets of data or portions thereof may only be sent to user devices that share a common interest, permission, or access level associated with a set of rules. FIG. 3 begins with step 310 where levels of trust are received. This may include a first user of a first device providing inputs to a user interface that associates licensees (i.e. other users) with levels of trust. Each licensee may be assigned a different trust level. Next in step 320, the first user may assign levels of intimacy to each of these licensees. Each licensee of a first user may be assigned a different level of intimacy. In certain instances, steps 310 and 320 may be performed for each respective licensee sequentially. This process may also include providing information that associates contact information with information that identifies user devices of each licensee. Each of these user devices may have a respective unique identifier that allows data to be sent to them by any of the ways discussed in respect to FIGS. 1-2. Exemplary unique device identifiers may include a phone number, a unique code, an avatar or other means that link a device such as a smartphone to a particular user. Such identifiers may be used to direct data sent from a computing device to one or more other computing devices. This may include sending data through a server (such as distribution server 140 or transfer/signal server 150 of FIG. 1) configured to securely transfer data.

Such methods may include sending data to one or more destinations using any identifier or identifiers (i.e. an email address, an identifier associated with a distribution server, a transfer/signal server, a universal resource locator (URL), a quick response (QR) code associated or a code stored at a near field communication—NFC—tag, another unique code, an avatar or other means) that link a device such as a smartphone to a particular user. By merely providing data to a computer that transfers received data, communications that include or are comprised of encrypted data may allow this transfer computer to distribute data to devices without the transfer computer being able to decrypt or fully decrypt encrypted the transferred data.

When a collaboration effort includes multiple user devices, data may be shared between user devices in a manner consistent with an agreement made between parties of the agreement. For example, one collaborator may be a University that has developed a particular technology and another collaborator may be a scientist developing a product based on the particular technology developed by the University. The scientist may work with others (e.g. students or laboratories) that may perform tests on products developed by the scientist or that may assist in the manufacture of the product. Rules may be used to associate what information that the University may share with the scientist and may identify information that can be shared with particular assistants of the scientist. Sets of rules may also identify information that the scientist or the scientists assistants that should be shared with the University. Information sharing may be controlled according to levels of trust, intimacy, and possibly interest. In this way only the scientist and the University, for example, may be aware of certain information, where the scientist's assistants only may access information based on matching levels of trust, intimacy, and possibly interest.

As discussed above data may be transferred directly between user devices, using a transfer/signal server, or distribution server computer. Particular user devices may be allowed to receive data and in certain instances, a portion of that shared data may be forwarded to other devices based on a set of rules. The forwarding of this data may be based on the shared data including art identifier sent with the shared data. For example, when the identifier is a phone number, data may be sent to a cell phone associated with the phone number. Encrypted data may be decrypted by the cell phone based on that cell phone having shared encryption keys as discussed in respect to FIG. 2. In an instance when the identifier appears to be an email address or a URL to a person based on human readable text, that email address or URL may be may really be a pointer to that points to a recipient device or to a transfer computer. Data included in information sent to the apparent “email address” or “URL” cold include information that appears to be clear text (unencrypted data) that is really information that includes identifiers to devices to which data should be sent. This could include converting an email address, a URL, or the apparent clear text to identifies that identify one or more particular destination devices. Such methods may also be employed when QR codes or other codes are used. An initial set of information (e.g. email address, URL, clear text, QR code, or NFC code) may map to particular user devices. A transfer computer or a user device that receives such sets of information may be configured to convert that information to identifiers that identify particular user devices that have the capability of decoding encrypted data within a set of transmitted data. In this way even device identifiers may be obfuscated from a zone of the Internet.

For each pair of users, x and y, with x the initiator of art action on the network and y the receiving party, user x may elect to maintain a file or dossier Dₓ(y) on any of his or her licensees or collaborators belonging to a group denoted by the group [Pₓ(y)] of his or her most personal licensees or collaborators, or so called personal ‘peeps.’ This file may contain all forms of data representing user y as seen thru the eyes of user x, some of which may be numerical, others descriptive, and still others in the form of text remembrances, stories, impressions and the like as a form of instant recall or mental prosthesis. As these are but impressions of user x about user y, they may not even be accurate or factual, but merely what user x understands of user y.

The first user may enter information via a user interface that associates particular licensees or collaborators with contact interest parameters in step 330 of FIG. 3. Contact data and contact interest parameters may be stored as sets of dossier data in a user's Dₓ(y) file of dossiers, including one's own dossier Dₛ(x). This may be performed by a user making selections from a set of interests or other information, may include the first user entering text that describes an interest, or both.

For example, the first user may enter an interest of material science collaboration. This may also include entering a collaboration level for contacts that like to are part of the collaboration. A first user, Alex may identify that his contact Bob is a researcher that tests materials, that his contact Joe is a student that performs tests under Bob's supervision, and that his contact Adam is assigned the tasks of tracking materials used as part of the research. When Alex drafts a message regarding a test or that includes test data, that message may be filtered based on trust levels, intimacy levels, interest types, and possibly interest levels. When Alex wishes to plan a new test, he may draft a message in step 340 and he may then configure that message with levels of trust, intimacy, and possibly a type of interest. This may also include configuring the message or other data to be sent only to contacts that have a minimum interest level of researcher. This may allow only Bob to receive this message or and related data. Step 350 may include receiving text typed into a user interface at the first user device. When the data includes message data, that data may be received by a user speaking into a microphone. Here text may be transcribed into a message using voice recognition.

In an instance when Alex plans a set of tests that require the support of all intimacy levels, Alex may identify that a message he drafts or data he provides may be sent to all contacts that that participate in the collaboration. Alternatively, Alex may stipulate that only contacts that have at least a medium trust levels and medium intimacy levels should be sent this message or data. The message or data may then be sent to user devices that belong to such a filtered set of contacts in step 360 of FIG. 3. This filtered set of contacts may be referred to as a group of contacts that “compatible” with parameters, information, or ratings associated with the message or data.

When the steps of FIG. 3 are directed to sharing licensed content, that licenses content may be stored in step 340. This may include sending the licensed content or portion of licensed content to a distribution server for storage. A user may authorize the sharing of licensed content with a second user via a user device of the second user in step 350 of FIG. 3. Keys may be shared with respective computing devices as discussed in respect to FIG. 2. Step 350 may also filter the shared content according to levels of trust, intimacy, and possibly interest. This could allow portions of the licensed content from being removed from data that the second user may review. For example, the level of trust may identify a title of a book, a level of intimacy may correspond to an age or demographic of the second user, and the level of interest may identify portions of content in the book that should not be shared with individuals of a certain age group or demographic. This means that certain content (e.g. sexually explicit content) may be removed from the content shared with individuals that are less than 18 years old. In this way a book with a restricted (R) level of content rating or an explicit (x) level rating may be removed from the shared content according a set of sharing rules. This may allow particular portions of content to be shared with only devices of users according to the set of sharing rules in step 360 of FIG. 3.

After step 360 program flow may move to determination step 370 that identifies whether a key should be withdrawn, when no, program flow may move back to step 310 where the process of FIG. 3 may begin again. When determination step 370 identifies that a key should be withdrawn, program flow moves to step 380 where the key is withdrawn. As mentioned above this may result in keys being deleted/erased or put into a withdrawn state at a user device and/or at a distribution server.

Note that each of the user devices that a user X identifies as part of his or her group in his or her personal media network. Because of this and a multitude of additional features and capabilities disclosed herein, the present disclosure, involving personal ratings of others and their attached dossiers, along with ways and means of selecting as well as blocking communications therewith. Methods of the present disclosure may include ways of automating the selection of ad hoc groups to communicate based on trust, intimacy and other information. This may include the use of tagged parameters and ways of applying local protocols to individual links. This makes it clear that such personal media sites are far different from the popular but highly vulnerable and untrusted social media sites of today such as Facebook, Instagram and many others, where informed folks today avoid like the plague sharing their most private, secret, financial or sacred information in postings for fear of intrusions.

Instead, the present disclosure defines and enables a new form of Internet and its media architecture that deserves to be characterized as ‘personal media.’ This personal media is empowered by a distributed node topology network that functions via: 1) peer-to-peer encrypted communications architecture, 2) minimal server interactions, which are always out of reach of commercial networks and big data intrusions on privacy, 3) ways of communicating among users secured by the highest level of privacy and security, along with and further enabled by client ratings on trust and intimacy/closeness between individuals, 4) by matching messages/data to their audience via search, filtering and other capabilities using personal dossiers, only stored on users private devices, and thus out of the reach of public and commercial networks, 5) new convenient high speed ways of selecting just the right ad hoc audience for a message or data, 6) an architecture that fosters and enables the evolution and use of smart contracts, and 7) communication rules and protocols defined on individual peer to peer links by the peers themselves that are non-commutative. Herein, locally stored private dossiers of personal contacts information act to empower and sustain the quality of the communications between parties that memory alone can seldom match. All of which will tend over time to raise trust and confidence and bring users and user groups ever closer together.

Rules set by a user on a node-by-node basis are not limited to specific levels of trust and intimacy, but may, for example, use rules that governs minimum levels of trust and intimacy and various other specifications. In such an instance a rule may identify that user devices of contacts that share the interest of baseball that have (say) a minimum trust level of medium and a minimum intimacy of medium should be sent a particular message or data. Here user devices of users that have a range of trust and intimacy levels and an interest in a subject will be sent the message or data according to a sharing rule. Given these and similar conditions, user devices belonging to contacts that have an interest in baseball that have trust/intimacy levels of (say) high-high, medium-high, high-medium, and medium-medium and no others will be sent this message or data according to such a sharing rule. These rules may be unique for any pair of users or user group, they provide a high degree of personalization and flexibility to users.

The combination of elements of trust (T), intimacy (I), and possibly interest (A) corresponds to a confidence or sentiment level C=Cₓ(y,Tₓ, Iₓ, A) for individual pairs x and y of users. This sentiment may also be used to control the nature, degree, and content that user x is willing to transmit to a computing device of user y in a message or data Mₓ(y) that can only be sent to specific users. That given, the following are steps that may be followed for user x to send its message/data Mₓ(y) to user y. Once x has chosen the general nature of his or her message/data, that message/data be assigned a confidence rating C in terms of T, I, & A. By matching this, the confidence level required by user x for his message/data to go to a proposed recipients list, may be limited to those with an equal or greater confidence rating, or C levels.

With such message/data confidence ratings Cₓ, set by user x, a processor executing instructions out of a memory may identify which messages/data can be supplied to specific contacts of a user x to users y, zs that have a suitably high enough sentiment rating in terms of T, I, and A ; and by such means and inventions, by a few quick strokes, enable and automate the selection of a small or large cohort suitable and qualified to receive a specific message or data. Which means are employed for the convenience of user x and also so he or she may save a good deal of time and effort.

A processor of a computing device of user x may access structured data of user x stored alongside node nₓ in the network to provide information that allows user x to contextualize and enrich a message/data user he or she is drafting. This allows user x to draft messages/data that are suitable, sensitive, precise, appropriate, and useful.

The personal dossiers mentioned above may include information (i.e. parameters) that identifies levels of trust and intimacy that a particular user has associated with their contacts. These dossiers may also induct information that identifies interests of their contacts. Once an individual has associated a set of parameters with a particular set of data, contacts that have a matching set of parameters may be identified and each of these contacts may be sent that particular data set. Because of this, dossier data of a large number of contacts may be filtered through to identify only those contacts that are “compatible” with rating parameters associated with a particular message or data set. For example, in an instance when a user has 100 contacts and has assigned a level of trust of 3, an intimacy of 2, and an interest of travel to a message, only contacts that have a compatible level of trust, level of intimacy, and interest in travel will be sent the message or data. This may result in only 10 of the user's 100 contacts being sent the message. The present process allows for data to be shared with compatible contacts virtually using a single stroke according to a set of rules based on previously entered dossier data and based on a set of parametric information assigned to the message or data set.

Security and privacy of message data may be maintained by using a combination of techniques associated with the National Institute of Standards and Technology (NIST) standards and a secure hash algorithm of various sorts. For example, the 256-b secure hash algorithm (commonly referred to as the SHA-2 hash algorithm) developed by Massachusetts Institute of Technology (MIT) may be used as part of a security protocol. Other examples of hash algorithms that may be used include yet are not limited to the MD5 and Script algorithms. Security may also be enhanced by using an extended triple Diffie-Hellman secure key exchange that is sometimes referred to as X3DH that establishes a shared secret key between different parties (i.e. computing devices or compute nodes) that mutually authenticate each other using public keys. Using a technique such as X3DH provides the benefits of forward secrecy and cryptographic deniability. This X3DH technique may be used for asynchronous settings where one user, “Bob,” is offline yet has published some information to a server. This may allow device nodes to leverage extended triple Diffie-Hellman security in a node centric system where some communications may be made to a private server. Such a private server may be a private signal server that executes instructions associated with a forked or derivative version of open source “signal” code or may be a distribution server as discussed in respect to FIG. 1. This may allow for a node centric system that is not completely and totally decentralized disintermediate WEB 3.0 or semantic WEB and Blockchain technologies. This may also provide users with increases in privacy security and may help leverage processing power based on the client being a node by which communications are conducted. These methods may also use end to end encryption through devices implementing a form of open source signal code server, for example. Despite having minimal server calls to support communications, private computers or computer networks may have no access to information stored on a computing device (e.g. a computer or phone) of a user. Such a design allows for data sent between nodes to be secured at and only accessible by specific nodes that receive data sent from another node in a private media network.

In certain instances, levels of trust and intimacy may be assigned using color codes. Trust and intimacy levels may be assigned, to discrete content included in data sent between nodes. Color highlights or colored text may be added to licensed content or to content that is part of a collaboration. These colors may be combined with a bias that may adjust filtering of specific portions of text. The data of table 3 identifies how colors may be interpreted. The colors identified in table 3 are red, pink, orange, yellow, and none. These colors may be used to identify content that is not appropriate for certain individuals to receive. For example, color may be used to identify R or X rated content or color may be used to identify classifications of users of a collaboration that may or may not receive certain content.

TABLE 3
Trust/Intimacy Combined Color Codes

| | Trust, | Trust, | |
|---|---|---|---|
| | Intimacy | Intimacy | Trust, Intimacy |
| Numeric & | 3, 1: Orange | 3, 2: Pink | 3, 3: Red |
| Color | 2, 1: Yellow | 2, 2: Blue | 2, 3: Pink |
| Trust/Intimacy | 1, 1: None or | 1, 2: Yellow | 1, 3: Orange |
| Representation | Green | | |

In table 3, the color red may correspond to a highest level of sentient, where trust and intimacy (3, 3) are both high. The color blue may correspond to a medium level of both trust and intimacy (2, 2). No color or a green color may correspond to a lowest sentiment/confidence level both trust and intimacy (1, 1). The colors pink (T/I of 3, 2 or 2,3), orange (T/I of 3, 1 or 1, 3), and yellow (T/I of 2, 1 or 1,2) may be used to identify text of some intermediate level that may be raised or lowered to a high, medium, or low sentiment/confidence level based on another set of settings. These other settings may identify that text of a particular intermediate level should be raised to a next higher level or lowered to lower level. Pink combined with a raise may result in a high sentiment level (e.g. 3, 3 red), pink combined with lower may result in a medium sentiment level (2, 2 blue), orange combined with a raise setting may result in a medium sentiment level (2, 2 blue), orange combined with a lower setting may result in a low sentiment level, yellow combined with a raise sentiment level may result in a medium sentiment level, and yellow combined with a lower sentiment level may result in a low sentiment level.

The use of color highlighting or text (e.g. green) may be used to identify text that may be broadcast to arty contact from a primary device and that may possibly forwarded to secondary contacts. Other text in that message or data set may be transmitted to primary contacts or secondary contacts based on other settings (e.g. an overall sentiment—trust/intimacy—level).

Methods of the present disclosure may allow user Sam D. to assign specific contacts with discrete levels of trust and intimacy. This may be accomplished by making entries in a user interface. This process may include identifying specific devices that belong to their respective contacts. For example, a user may assign their friend Nancy A. with a medium level of trust (e.g. the letter B) and a high level of intimacy (e.g. the letter A) and may identify a user device that belongs to Nancy A. with a phone number of (510) 555-0101. This method may also include associating specific content with levels of trust and intimacy.

In certain instances, phone numbers or other identifiers may be hashed and/or salted to ensure a standard long form key output. Such techniques may prevent nefarious actors from colluding in attempts to interfere with or inappropriately access data associated with (i.e. hack) the system. This may include a cryptographic hash of an identifier (and/or other information) or adding random bits to the identifier (and/or other information) and performing a cryptographic hash of the random bits and the identifier (and/or other information).

Rules could be used to allow a processor of Sam's user device to identify which messages or data that Sam drafts that will be sent to other user devices. Any messages or other shared data sent from Sam's user device to Nancy's user device must conform to the rules set by Sam. Such a rule could identify that message or data A can only be sent to devices of users that have been assigned a trust/intimacy rating of B, A (medium trust, high intimacy).

A processor executing instructions out of a memory may also make other evaluations when identifying which message or data set should be sent to which specific user devices. These other evaluations could identify users that share a common interest, for example in a research project. In such an instance, messages that relate to that project could be sent to user devices according to a message rule that associates the interest of skiing with specific trust and intimacy levels. This rule may specify that a message associated with the interest of the project can only be sent to user devices that are assigned a medium trust level and a high intimacy level. In an instance when a user device owned by Sam D. sends messages or data to user devices of Sam's contacts, that the user device of Nancy A. will be sent that message or data set.

User x may add various rules on how the message or data can be transmitted to users y, including controls over the content of messages or data passed on, or portions of data therein, that may be forwarded by users y to those that have licensed content or that are part of a collaborative pursuit. The nature of the data may necessitate other rules to guide the level of security and privacy that is required prior to such transmission. Plus, perhaps, feedback to the originating user x on how its signal was received and perhaps further transmitted.

When user y attempts to reply to this message or set of received data, it may be based on his or her (possibly different) level of confidence in user x, Cy(x) based on different T, I, and A levels than user x used in data sent to user y, i.e., non-commutativity. Further, on the basis of Cy, y may not even be willing or able to reply at all. Herein we have the benefit of non-commutativity commonly present in face to face human communications, where how a party A feels about a contact B can differ greatly in how party B in return feels about and acts toward party A.

Whenever a user x wishes to cast his or her message or data or posting beyond their own personal star of contacts Pₓ(y), they can only do so with the concurrence and assistance of one or more of their users y. Meaning y agreeing to pass the posting on to his or her group of collaborators P_{y}(z). This may be enabled, layer by layer, with consent, over a selection of surrounding users of user y from his or her circle P_{y}(z). Herein its members z would receive the data (or portions of that data) and possibly have it go on and on with their consent to other nodes in a similar fashion. This may allow users to communicate in an outbound fashion broadly, where at each node any further forwarding is based on permission as well as a variety of trust T and intimacy I filters along the network.

The method by which this can be established, may control and monitor the transfer of messages or data sets by applying a set of to be node-centric based rules that ensure that the sensitive nature of the original message or data is fully preserved across a span of the message's reach. In order to accomplish this objective, the original message or data set may be provided with redacting rules as it is propagated across many user devices of users in the [Pₓ(y)], [P_{y}(z)], [P_{z}(u)] stars of contacts of an x, or y, or z . . . associated with their star configurations. Such redacting rules may provide indicators to recipients reminding them to limit their forwarding of the message or data to parties that meet a specific indicated level of trust, intimacy, and possibly known interest. Alternatively, or additionally redacting rules may be automatically enforced based on a set of rules that may have been shared between devices.

Such resending of an original message or data set may depend on the confidence or sentiment levels Cₓ, C_{y}, C_{z} . . . of the star systems surrounding users x, y, and z, namely the sets [Pₓ(y)], [P_{y}(z)], [P_{z}(u)]. . . . This ensures localized rules based on trust and intimacy continue to be honored across the greater network of linked nodes. As a result, various complex architectures can be put in place that meet the local node-centric non-commutative nature of the network while preserving the integrity of the messages or data sets that are propagated broadly across such star clusters within the network.

Methods of the present disclosure allow copyrighted or patented content to be shared in a manner that is consistent with the fair use legal doctrine of the United States or other countries. The fair use doctrine allows for certain content to be used by others even though that content is owned by another. For example, copyrighted content may be criticized, commented about, reported about in news feeds, used in teaching materials, referred to in scholastic endeavors, and may be used as a basis of research. Generally, use of copyrighted material is allowed in nonprofit educational and in noncommercial settings. Furthermore, contents relating to technological or new related information is sometimes considered as content that is more easily justifiable as being shared via fair use than creative works (e.g. novels, songs, or movies). The sharing of a small portion of a set of copyrighted materials may be considered as “fair use”, where the sharing of a large portion that same set of copyrighted materials may be considered as not being “fair use” of that set of materials. Another metric that may be used to identify what is fair use and what is not fair use is directed to whether the use of the copyrighted or patented materials harms an existing or future market associated with the materials. Currently, there is a need to improve and expand upon using copyrighted or patented materials in ways that are consistent with the fair use doctrine while expanding the ability of owners for such materials and the society as a whole to benefit from such materials.

Current DRM management systems that share large sets of data, for example, video files of feature films, are often expensive to manage because of their size and complexity. Such large systems are also more susceptible to exploitation as content may be accessed and shared when companies that host such content do not apply adequate resources to prevent content from being shared appropriately. By reducing complexity, by using distributed ledger technology, and by sharing data using non-commutative node-centric rules, methods of the present disclosure protect content in ways that large DRM management systems cannot.

Methods and apparatus of the present disclosure may use levels of trust, intimacy, and possibly interest when identifying portions of content that cart be shared with certain individuals. For example, content owned by the University discussed above may be shared with a scientist, students, and laboratory personnel based on levels of trust, intimacy, and interest. Here again the scientist and the University, for example, may be aware of certain information, where the scientist's assistants (students or laboratory personnel) may only may access information based on matching levels of trust, intimacy, and possibly interest.

Methods of the present disclosure may also use a form of “automatic fair use.” In such instances, servers may be configured to provide keys and allow protected use of a server-side key to allow data sharing between the server and a user device, where a owner of the content may revoke access by withdrawing a key, for example, when the content owner becomes aware that a user of the user device has exploited terms of a fair use policy. This may allow for data to be shared according to fair use policies in a manner that has a minimal overhead using node to node content sharing rules consistent with the present disclosure. In certain instances, multiple sets of content owned by different entities may be shared in a manner where each owner of a set of intellectual property (IP) or content using any number of keys (e.g. the two or three keys discussed above, or some other number of keys). Different sets of content may be protected by use of five keys. For example, two sets of content may be shared with a user device when this content is associated with five keys. A first content owner may be in a position to withdraw a first key and a second content owner may be in a position to withdraw a second key. Revocation of either the first or the second key respectively by the first owner or the second owner may result in the user device no longer having access to the protected content. Such methods could allow for a form of group IP/content access control and/or development. These methods may be scale-able in a manner that allows any number of content owners to participate in sharing certain data sets.

Methods and apparatus of the present disclosure overcome limitations and inequities inherently associated with a large entity acting as an agent to distribute protected content (e.g. copyrighted content). This is because when content of a smaller is shared in a limited way from one node to another node, a single security breach of a single computer could only provide a hacker with access to data that only belongs to a single entity or a small group of collaborators. In contrast, a single security breach of a computer that belongs to a large entity that provides access to content that belongs to many smaller entities renders content belonging to all of these smaller entities at risk of being stolen. An inequity that methods and apparatus consistent with the present disclosure resolves is that large entities are in a position to collect a significant portion of fees paid by users to access protected content. In fact, these large entities are positioned to collect a significant or higher percentage of fees from users who access protected content than the smaller entities that own the content. This means that large entities provide content owners with greater risk and with higher costs.

Distributed ledger technology when used to enforce node to node data sharing help protect protected content because each individual set of content represents a relatively small prize to hackers while providing hackers with the high cost of attempting to implement a security breach.

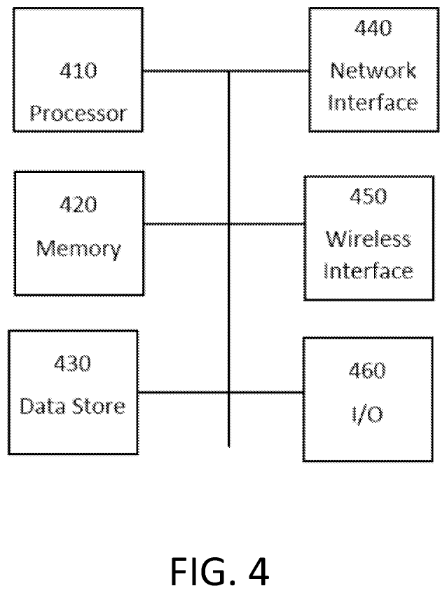

FIG. 4 illustrates a computing system that may be used to implement an embodiment of the present invention. FIG. 4 includes processor 410 that may execute instructions out of memory 420. FIG. 4 also include mass data store 430, network interface 440, wireless communication interface 450, and input/outputs (I/O) 460. Processor 410 may execute instructions out of memory 420. Communications may be sent via communication interface 440 or via I/O 460 to other computing devices.

The computing device of FIG. 4 may be a device such as a desktop computer, notebook computer, tablet, or cell phone computing device A network interface or wireless communication interface may communicate with a remote computing device. Computing devices consistent with the present disclosure may also include a display that displays a user interface that allows users to set levels of trust and intimacy. This display may also be used to prepare messages or data sets to send or to display received messages or data. Wired network connections may include any standard wired network known in the art (Ethernet for example). Wireless communications may include communication signals consistent with cell phones, with 802.11 Wi-Fi, Bluetooth, radio, cellular, or other wireless communication mediums.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method for selectively sending messages, the method comprising:
receiving from a first user device a trust level and an intimacy level to associate with a second user and with a set of data, wherein the trust level and the intimacy level associated with the second user correspond to a rule for providing the dataset to a second user device;
storing information that identifies the second user device, wherein the stored data also associates the trust level and the intimacy level with the second user device identifying information;
initiating a key exchange process that results in a first key being stored at the first user device and at least one other key being provided to the second user device; and
allowing the second user device to access the dataset according to the trust level and the intimacy level based on the stored data associating the trust level and the intimacy level with the second user device identifying information.

2. The method of claim 1, wherein the key exchange results in a second key being provided to a distribution server and the second user device is provided the dataset via the distribution server after the distribution server applies the second key.

3. The method of claim 2, wherein the second key and the at least one other key are also stored at the first user device and the second user device applies the at least one other key to decrypt the dataset provided for receipt by the second user device.

4. The method of claim 1, further comprising licensing the dataset to the second user. The method of claim 1, further comprising withdrawing an access privilege that allows the second user device to access the dataset.

6. The method of claim 5, wherein the key exchange results in a second key being provided to a distribution server and the second key is disabled based on the withdrawal of the access privilege.

7. The method of claim 5, wherein the second key is disabled by deleting the second key at the distribution server.

8. The method of claim 1, further comprising receiving information from a third user device based on a user of the third user device being part of a collaborative effort associated with a user of the first user device and the second user.

9. The method of claim 2, further comprising:
providing at least one portion of the dataset to the distribution server such that the distribution server can provide the at least one portion of the data set to the second user device; and
sending one or more portions of the dataset for receipt by the second user device via a pathway that does not include the distribution server.

10. The method of claim 9, wherein the sending of the one or more portions of the dataset for receipt by the second user device via the pathway that does not include the distribution server is performed after failure of the distribution server.

11. The method of claim 1, further comprising receiving information identifying that a payment associated with the dataset have been distributed has been fulfilled.

12. The method of claim 11, wherein the payment is fulfilled using digital tokens.

13. A non-transitory computer-related storage medium having embodied thereon instructions executable by one or more processors for selectively sending messages, the method comprising:
receiving at a first user device a trust level and an intimacy level to associate with a second user and with a set of data, wherein the trust level and the intimacy level associated with the second user correspond to a rule for providing the dataset to a second user device;
storing information that identifies the second user device, wherein the stored data also associates the trust level and the intimacy level with the second user device identifying information;
initiating a key exchange process that results in a first key being stored at the first user device and at least one other key being provided to the second user device; and
allowing the second user device to access the dataset according to the trust level and the intimacy level based on the stored data associating the trust level and the intimacy level with the second user device identifying information.

14. The non-transitory computer-related storage medium of claim 13, wherein the key exchange results in a second key being provided to a distribution server and the second user device is provided the dataset via the distribution server after the distribution server applies the second key.

15. The non-transitory computer-related storage medium of claim 14, wherein the second key and the at least one other key are also stored at the first user device and the second user device applies the at least one other key to decrypt the dataset provided for receipt by the second user device.

16. The non-transitory computer-related storage medium of claim 13, further comprising licensing the dataset to the second user.

17. The non-transitory computer-related storage medium of claim 13, further comprising withdrawing an access privilege that allows the second user device to access the dataset.

18. The non-transitory computer-related storage medium of claim 17, wherein the key exchange results in a second key being provided to a distribution server and the second key is disabled based on the withdrawal of the access privilege.

19. The non-transitory computer-related storage medium of claim 17, wherein the second key is disabled by deleting the second key at the distribution server.

20. An apparatus comprising:
a memory; and
one or more processors executing instructions out of the memory to:
access data received from a first user device a trust level and an intimacy level to associate with a second user and with a set of data, wherein the trust level and the intimacy level associated with the second user correspond to a rule for providing the dataset to a second user device;
store information that identifies the second user device, wherein the stored data also associates the trust level and the intimacy level with the second user device identifying information;
initiate a key exchange process that results in a first key being stored at the first user device and at least one other key being provided to the second user device; and
allow the second user device to access the dataset according to the trust level and the intimacy level based on the stored data associating the trust level and the intimacy level with the second user device identifying information.
